(19) United States
(12) Patent Application Publication
(10) Pub. No.: US 2025/0329716 A1
(43) Pub. Date: Oct. 23, 2025

(54) POSITIVE ELECTRODE ACTIVE MATERIAL, POSITIVE ELECTRODE PLATE, AND NON-AQUEOUS ELECTROLYTE SECONDARY BATTERY

(71) Applicant: Prime Planet Energy & Solutions, Inc., Tokyo (JP)

(72) Inventor: Kotaro USHIJIMA, Kobe-shi (JP)

(21) Appl. No.: 19/181,327

(22) Filed: Apr. 17, 2025

(30) Foreign Application Priority Data
Apr. 22, 2024 (JP) 2024-068913

(51) Int. Cl. H01M 4/36; C01G 53/504; H01M 4/02; H01M 4/38; H01M 4/525

(52) U.S. Cl. CPC H01M 4/366; C01G 53/504; H01M 4/38; H01M 4/525; C01P 2002/50; C01P 2004/32; C01P 2004/50; C01P 2004/61; C01P 2006/40; H01M 2004/021; H01M 2004/028

(57) ABSTRACT

A positive electrode active material comprises a first active material having an average particle size (D50) from 2 to 10 μm, and a second active material having an average particle size (D50) from 12 to 20 μm. The first active material includes first particles that are a lithium-(transition metal) composite oxide, the first particles are at least one of single particles and secondary particles, and the secondary particles each consist of 2 to 10 primary particles aggregated together. The second active material includes second particles that are a lithium-(transition metal) composite oxide, and the second particles are secondary particles each consisting of 50 or more primary particles aggregated together. The second active material has a sphere degree from 0.770 to 0.810.

### CROSS REFERENCE TO RELATED APPLICATIONS

This nonprovisional application is based on Japanese Patent Application No. 2024-068913 filed on Apr. 22, 2024, with the Japan Patent Office, the entire contents of which are hereby incorporated by reference.

### BACKGROUND OF THE INVENTION

### Field of the Invention

The present invention relates to a positive electrode active material, a positive electrode plate comprising the same, and a non-aqueous electrolyte secondary battery having the positive electrode plate.

### Description of the Background Art

It is known to use, as a positive electrode active material, two types of lithium-(transition metal) composite oxides different in average particle size (D50). Japanese Patent Laying-Open No. 2023-091566 discloses a means for reducing gas production at the time of storage of a non-aqueous electrolyte secondary battery that has the above type of positive electrode active material, for achieving good cycling performance.

### SUMMARY OF THE INVENTION

Non-aqueous electrolyte secondary batteries are sometimes exposed to high-temperature conditions, and therefore demanded to have excellent cycling performance even under high-temperature conditions.

The present disclosure aims at providing a positive electrode active material that is capable of reducing gas production at the time of storage of a non-aqueous electrolyte secondary battery, and is also capable of reducing degradation of capacity retention at the time of repeated use of the non-aqueous electrolyte secondary battery under high-temperature conditions.
[1] A positive electrode active material comprising:
   a first active material having an average particle size (D50) from 2 to 10 μm; and
   a second active material having an average particle size (D50) from 12 to 20 μm, wherein
   the first active material includes first particles that are a lithium-(transition metal) composite oxide, the first particles are at least one of single particles and secondary particles, the secondary particles each consist of 2 to 10 primary particles aggregated together,
   the second active material includes second particles that are a lithium-(transition metal) composite oxide, the second particles are secondary particles each consisting of 50 or more primary particles aggregated together, and
   the second active material has a sphere degree from 0.770 to 0.810.
[2] The positive electrode active material according to [1], wherein both the first particles and the second particles include Ni at 50 mol % or more relative to a total number of moles of metallic element except Li.
[3] The positive electrode active material according to [1] or [2], wherein an average particle size value that is obtainable by averaging particle sizes of the single particles included in the first particles and the primary particles constituting the secondary particles included in the first particles is from 2 to 6 μm.
[4] The positive electrode active material according to any one of [1] to [3], wherein an average primary particle size of the primary particles constituting the secondary particles of the second particles is from 1.2 to 2.0 μm.
[5] The positive electrode active material according to any one of [1] to [4], wherein
   the second active material further includes a covering layer that covers at least part of a surface of each second particle, and
   the covering layer includes one or more elements selected from the group consisting of B, Al, Co, Mo, W, Ga, In, and Ti.
[6] The positive electrode active material according to [5], wherein
   the covering layer includes B, and
   a content of B in the covering layer is from 600 to 1400 ppm relative to a mass of the second particle.
[7] A positive electrode plate comprising an active material layer including the positive electrode active material according to any one of [1] to [6].
[8] The positive electrode plate according to [7], wherein a density of the active material layer is from 3.0 to 4.0 g/cm³.
[9] A non-aqueous electrolyte secondary battery comprising the positive electrode plate according to [7] or [8].

The foregoing and other objects, features, aspects and advantages of the present invention will become more apparent from the following detailed description of the present invention.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table to set a new numerical range.

### (Positive Electrode Active Material)

A positive electrode active material according to the present embodiment (hereinafter also called “the present positive electrode active material”) is used in a positive electrode plate of a non-aqueous electrolyte secondary battery (hereinafter also called “a secondary battery”) such as a lithium-ion battery.

The present positive electrode active material includes a first active material having an average particle size (D50) from 2 to 10 μm, and a second active material having an average particle size (D50) from 12 to 20 μm. The first active material includes first particles that are a lithium-(transition metal) composite oxide (hereinafter also called “a composite oxide”), the first particles are at least one of single particles and secondary particles, and the secondary particles each consist of 2 to 10 primary particles aggregated together (hereinafter also called “first secondary particles”). The second active material includes second particles that are a composite oxide, and the second particles are secondary particles each consisting of 50 or more primary particles aggregated together (hereinafter also called “second secondary particles”). The second active material has a sphere degree from 0.770 to 0.810.

An active material layer of a positive electrode plate described below is formed by applying a positive electrode composite material slurry including a positive electrode active material to a positive electrode current-collecting foil sheet to form a coating layer on a positive electrode current collector, followed by, for example, compression of the resulting coating layer. The present positive electrode active material includes a first active material and a second active material that are different in average particle size (D50), and therefore it makes it possible to form an active material layer which has a high density of the present positive electrode active material and, thereby, makes it possible to enhance volumetric energy density of the secondary battery.

The second active material has a sphere degree within the above-mentioned range, so it can be said that its shape is anisotropic to some extent, not isotropic. Because of this, it is conceivable that at the time of forming an active material layer by using the present positive electrode active material, compression force applied to the second active material is moderately dispersed and thereby the compression force tends to be uniformly applied to throughout the entire coating layer, and as a result, the coating layer tends to be uniformly compressed. Consequently, conductive paths tend not to be cut during repeated charge and discharge of the secondary battery under high-temperature conditions, and thereby degradation of capacity retention can be reduced. In contrast, in the case of an active material having an isotropic shape, compression force applied during formation of the active material layer tends not to be dispersed well and thereby the coating layer tends not to be uniformly compressed, and as a result, conductive paths tend to be cut during repeated charge and discharge of the secondary battery under high-temperature conditions.

It is conceivable that when compression force is moderately dispersed during formation of the active material layer, the amount of compression force required for obtaining an active material layer with a certain density can be reduced, and stress applied to the second active material can be reduced. Accordingly, breakage of the second secondary particles of the second active material that can be caused by the compression force applied during formation of the active material layer can be reduced, and as a result, the amount of gas produced during storage of the secondary battery can be reduced. In contrast, in the case of a highly-anisotropic active material having a low sphere degree, it is conceivable that the compression force applied during formation of the active material layer tends to be dispersed well but more compression force tends to be required for obtaining an active material layer with a certain density. As a result, more stress is applied to the active material and thereby damage such as breakage tends to occur in the active material, which tends to increase the amount of gas produced during storage of the secondary battery.

The average particle size (D50) of the first active material is smaller than the average particle size (D50) of the second active material. The average particle size (D50) of the first active material is from 2 to 10 μm, and it may be from 2.5 to 8 μm, or may be from 3 to 6 μm. Herein, the average particle size (D50) is a particle size in volume-based particle size distribution at which cumulative frequency of particle sizes accumulated from the small size side reaches 50%. The volume-based particle size distribution can be measured with a laser-diffraction particle size distribution analyzer.

The first active material is simply required to include first particles, and the first active material may include first particles and a first covering layer that covers at least part of the surface of each first particle. The first covering layer can include, for example, an element that may be included in a second covering layer described below. Whether the first active material has a first covering layer can be identified by X-ray photoelectron spectrometry (XPS) analysis. The first active material is preferably first particles, and it may be first particles having a first covering layer.

The first particles are at least one of single particles and first secondary particles. The first particles may be single particles, or may be first secondary particles, or may be a mixture of single particles and first secondary particles. The number of primary particles aggregated together to form each first secondary particle may be from 2 to 8, or may be from 2 to 5, or may be from 3 to 5. Herein, the number of primary particles aggregated together can be determined in an SEM image captured with a scanning electron microscope (hereinafter also called “SEM”), for example.

The average particle size value that is obtainable by averaging the particle sizes of the single particles included in the first particles and the primary particles constituting the first secondary particles included in the first particles (hereinafter also called “a particle size average”) is preferably from 2 to 6 μm, and it may be from 2.3 to 5.8 μm, or may be from 2.5 to 5.5 μm, or may be from 3 to 5 μm. Herein, the particle size average is a value that is obtainable by examining particle surfaces of the first active material with a scanning electron microscope (SEM) to capture an SEM image, performing image analysis to determine the major-axis diameters (the longest major-axis diameters) of the single particles and the primary particles constituting the first secondary particles in the SEM image, and averaging the resulting major-axis diameters.

The first active material is at least one of single particles and first secondary particles and has an average particle size smaller than that of the second active material, so conductive paths tend not to be cut during repeated charge and discharge of the secondary battery and, also, the particles of the first active material tend not to become broken. Hence, the sphere degree of the first active material is not particularly limited. This is because the sphere degree of the first active material is less likely to greatly affect either the capacity retention during repeated charge and discharge of the secondary battery under high-temperature conditions or the amount of gas produced during storage of the secondary battery.

The sphere degree of the first active material may be the same as or different from the sphere degree of the second active material, and preferably, it is close to the sphere degree of the second active material. The sphere degree of the first active material is from 0.650 to 0.950, for example, and it is preferably from 0.700 to 0.850. It is conceivable that when the sphere degree of the first active material is close to the sphere degree of the second active material, compression force applied during formation of the active material layer tends to be dispersed well. Herein, the sphere degree of the first active material is obtained by examining the particle surface of the first active material to capture an SEM image, performing image analysis to measure an area S₁ of the first active material and an peripheral length Li of the first active material, and calculating the ratio between the radius of a hypothetical perfect circle whose area is the same as the area S₁ and the radius of a hypothetical perfect circle whose circumference is the same as the peripheral length L₁. Specifically, the sphere degree of the first active material is calculated by the following equation (i).

$$Sphere degree = 4 π {S}_{1} / {{L}_{1}}^{2} \qquad ( i )$$

When the sphere degree is 1, it is theoretically considered that the first active material is a sphere. The closer the sphere degree is to 1, the more isotropic the shape is considered to be, and the farther the sphere degree is away from 1, the more anisotropic the shape is considered to be.

The average particle size (D50) of the second active material is greater than the average particle size (D50) of the first active material. The average particle size (D50) of the second active material is from 12 to 20 μm, and it may be from 13 to 19 μm, or may be from 14 to 18 μm, or may be from 15 to 18 μm. The combination of the average particle size (D50) of the first active material and the average particle size (D50) of the second active material can be freely selected without departing from the above-mentioned ranges.

The second active material is simply required to include second particles. As described below, the second active material may include second particles and a second covering layer (a covering layer) that covers at least part of the surface of each second particle. The second active material may be second particles, and preferably, it is second particles having a second covering layer.

The second particles are second secondary particles each consisting of 50 or more primary particles aggregated together. The number of primary particles aggregated together to form each second secondary particle may be 100 or more, or 1000 or more; and it is usually 5×10⁶ or less, and it may be 5×10⁵ or less.

Preferably, the average primary particle size of the primary particles constituting the second secondary particles of the second active material is smaller than the particle size average (described above) of the single particles and the first secondary particles constituting the first active material. The average primary particle size of the primary particles constituting the second secondary particles is preferably from 1.2 to 2.0 μm, and it may be from 1.25 to 1.8 μm, or may be from 1.3 to 1.7 μm. Herein, the average primary particle size is a value that is obtainable by examining particle surfaces of the second active material with a scanning electron microscope (SEM) to capture an SEM image, performing image analysis to determine the major-axis diameters (the longest major-axis diameters) of the primary particles constituting the second secondary particle in the SEM image, and averaging the resulting major-axis diameters. The combination of the particle size average and the average primary particle size can be freely selected without departing from the above-mentioned ranges.

The second active material has a sphere degree from 0.770 to 0.810. The sphere degree of the second active material is preferably from 0.770 to 0.800, more preferably from 0.780 to 0.800. Herein, the sphere degree of the second active material is obtained by examining the particle surface of the second active material to capture an SEM image, performing image analysis to measure an area S₂ of the second active material and a peripheral length L₂ of the second active material, and calculating the ratio between the radius of a hypothetical perfect circle whose area is the same as the area S₂ and the radius of a hypothetical perfect circle whose circumference is the same as the peripheral length L₂. Specifically, the sphere degree of the second active material is calculated by the following equation (ii).

$$Sphere degree = 4 π {S}_{2} / {{L}_{2}}^{2} \qquad ( ii )$$

As described above, with the second active material having a sphere degree within the above-mentioned range, compression force applied during formation of the active material layer is moderately dispersed, and stress applied to the second active material can be reduced. As a result, degradation of capacity retention during repeated charge and discharge of the secondary battery under high-temperature conditions can be reduced, and also the amount of gas produced during storage of the secondary battery can be reduced.

The sphere degree of the second active material can be regulated by changing the production conditions at the time of producing the second active material, and it can be regulated by changing the calcination conditions for producing the second particles as described below, such as, for example, the calcination temperature, the calcination time, and/or the number of calcination operations to perform.

The second active material may include a second covering layer (a covering layer) that covers at least part of the surface of each second particle. The covering rate which is the rate of covering with the second covering layer in the second active material with respect to the entire surface of the second particle, namely, the entire surface of the second secondary particle, is 50% or more, and it may be from 50 to 100%, or may be from 70 to 98%, or may be from 80 to 95%, or may be from 90 to 95%. The component constituting the second covering layer may enter into each second particle, namely, into the gaps between the primary particles constituting each second secondary particle. Whether the second active material has the second covering layer, as well as the covering rate with the second covering layer, can be determined by X-ray photoelectron spectrometry (XPS) analysis or high-frequency inductively coupled plasma atomic emission spectroscopy (ICP-AES).

The second covering layer can include one or more elements selected from the group consisting of B, Al, Co, Mo, W, Ga, In, and Ti. The element included in the second covering layer is preferably one or more elements selected from the group consisting of B, Al, and W, and more preferably, it is B.

When the second covering layer includes B, the content of B in the second covering layer relative to the mass of the second particle is preferably from 600 to 1400 ppm, and it may be from 700 to 1300 ppm, or may be from 800 to 1200 ppm, or may be from 900 to 1100 ppm. The content of B in the second covering layer can be determined by X-ray photoelectron spectrometry (XPS) or high-frequency inductively coupled plasma atomic emission spectroscopy (ICP-AES). The content of B in the second covering layer can be regulated by, for example, changing the amount of a boron source to add at the time of producing the second active material.

It is conceivable that in the second active material having a sphere degree within the above-mentioned range, the second covering layer tends to be uniformly formed on the surface of the second particle, as compared to an active material having a sphere degree below this range. Because of this, when the second active material having a sphere degree within the above-mentioned range is used, the amount of gas produced during storage of the secondary battery tends to be further reduced.

The composition of the composite oxide constituting the first particles may be the same as or different from the composition of the composite oxide constituting the second particles. The first particles and the second particles are independently a composite oxide that preferably includes Ni, more preferably includes Ni at 50 mol % or more relative to the total number of moles of metallic element except Li. Preferably, the first particles and the second particles are independently a nickel-cobalt-manganese-based oxide that includes Ni, Co, and Mn.

Preferably, the content of Ni in the first particles and that in the second particles relative to the total number of moles of metallic element except Li are independently 50 mol % or more, and they may be independently from 50 to 88 mol %, or from 52 to 85 mol %, or from 55 to 80 mol %, or from 57 to 75 mol %, or from 60 to 70 mol %. The content of Ni in the first particles may be the same as or different from the content of Ni in the second particles. Preferably, the content of Ni in the first particles is greater than the content of Ni in the second particles, but alternatively, it may be smaller than the content of Ni in the second particles.

When both the content of Ni in the first particles and that in the second particles fall within the above-mentioned ranges, a secondary battery with high capacity tends to be obtained.

The first particles and the second particles may be independently a compound represented by a formula (I), for example.

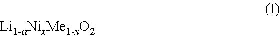

[In the formula (I),

$$- 0.3 \leq a \leq 0.2 and 0.5 \leq x \leq 0.88 ,$$

Me may include one or more types selected from the group consisting of Co, Mn, Al, B, Zr, Ti, Mg, Fe, Cu, Zn, Sn, Na, K, Ba, Sr, Ca, W, Mo, Nb, and Si.]

In the above formula (I), a may be −0.25≤a≤0.15, or may be −0.20≤a≤0.10. x may be 0.52≤x≤0.85, or may be 0.55≤x≤0.80, or may be 0.57≤x≤0.75, or may be 0.60≤x≤0.70. Me may include one or more types selected from the group consisting of Co, Mn, Al, B, Zr, Ti, Mg, Mo, and Nb, and preferably it includes at least one of Co and Mn, and more preferably it includes Co and Mn. The ranges of a, x, and Me can be set by freely combining the above-mentioned ranges.

The composition of the first particles and the composition of the second particles can be determined by high-frequency inductively coupled plasma (ICP) emission spectroscopy, for example.

The composite oxide constituting the first particles and the composite oxide constituting the second particles can be produced by mixing a lithium compound and a transition metal compound together and calcining the resultant. For example, the composite oxide can be obtained by calcining a first mixture that includes a lithium compound and a transition metal compound to obtain a calcined product, and then calcining a second mixture that includes the calcined product and a transition metal compound. Examples of the lithium compound include lithium hydroxide, lithium carbonate, and the like. Examples of the transition metal compound include a Ni-containing compound that contains Ni, and a NiCoMn-containing compound that contains Ni, Co, and Mn. The transition metal compound may be an oxide, or may be a hydroxide. The composition of the transition metal compound included in the first mixture may be the same as or different from the composition of the transition metal compound included in the second mixture. By changing the calcination conditions (the calcination temperature, the calcination time, the number of calcination operations to perform) for producing the composite oxide, for example, it is possible to regulate the average particle size, the form of particle aggregation, the sphere degree, and the like for each of the first active material and the second active material.

The first particles and the second particles obtained by the above-described production method may be used, as they are, as the first active material and the second active material, respectively. When the first active material includes the first covering layer, the first particles having the first covering layer may be produced by, for example, mixing together the first particles and an element source for forming the first covering layer and then subjecting the resulting mixture to heat treatment. When the second active material includes the second covering layer, the second particles having the second covering layer may be produced by, for example, mixing together the second particles and an element source for forming the second covering layer and then subjecting the resulting mixture to heat treatment. When the second covering layer includes B, boric acid can be used as a boron source, for example.

The mass ratio between the first active material and the second active material in the present positive electrode active material, (first active material):(second active material), may be from 7:3 to 3:7, or may be from 6:4 to 4:6, or may be from 5.5:4.5 to 4.5:5.5. When the mass ratio falls within the above-mentioned range, an active material layer formed by using the present positive electrode active material (described below) tends to be dense and the secondary battery tends to have high capacity.

The present positive electrode active material may include only the first active material and the second active material, or may further include another active material in addition to the first active material and the second active material. The total content of the first active material and the second active material in the present positive electrode active material relative to the total amount of the present positive electrode active material may be from 85 to 100 mass %, or may be from 90 to 100 mass %, or may be from 92 to 99 mass %, or may be from 95 to 98 mass %.

### (Positive Electrode Plate)

A positive electrode plate according to the present embodiment has an active material layer that includes the present positive electrode active material (hereinafter also called “a positive electrode active material layer”). Because the positive electrode plate according to the present embodiment includes the present positive electrode active material, it is possible to reduce gas production at the time of storage of the secondary battery, and also reduce degradation of capacity retention at the time of repeated use under high-temperature conditions.

The positive electrode plate can have the positive electrode active material layer on one side or both sides of a positive electrode current-collecting foil sheet. The positive electrode current-collecting foil sheet is a metal foil sheet that is formed with an aluminum material such as aluminum and aluminum alloy, for example. The positive electrode active material layer can further include one or more types selected from the group consisting of a conductive aid, a binder, and a thickener, in addition to the present positive electrode active material.

Examples of the binder include fluororesins such as polyvinylidene difluoride (PVdF) and polytetrafluoroethylene (PTFE); polyacrylonitrile (PAN); polyimide; acrylic resins; polyolefin; cellulose-based resins such as carboxymethylcellulose (CMC), methylcellulose (MC), and hydroxypropylcellulose; polyethylene oxide (POE); and the like. Carboxymethylcellulose (CMC) can also be used as a thickener. The binder can include one, two, or more types of the above-mentioned binders.

Examples of the conductive aid include a carbon material. The carbon material may be one or more types selected from the group consisting of fibrous carbon, carbon black (such as acetylene black, Ketjenblack), coke, and activated carbon, for example. Examples of the fibrous carbon include carbon nanotubes (CNTs). The CNTs may be single-walled carbon nanotubes (SWCNTs), or may be multi-walled carbon nanotubes such as double-walled carbon nanotubes (DWCNTs). The conductive aid can include one, two, or more types of the above-mentioned conductive aids.

The density of the positive electrode active material layer is preferably from 3.0 to 4.0 g/cm³, and it may be from 3.2 to 3.8 g/cm³, or may be from 3.3 to 3.7 g/cm³. When the density of the positive electrode active material layer falls within the above-mentioned range, a secondary battery with enhanced volumetric energy density tends to be obtained.

The density of the positive electrode active material layer can be regulated by changing the degree of compression of a below-described coating layer at the time of forming the positive electrode active material layer, the average particle size (D50) of the first active material and the second active material, the mixing ratio between the first active material and the second active material, and the like. The density of the positive electrode active material layer can be calculated as follows: the positive electrode plate is punched to obtain a punched piece having certain planar dimensions, and the mass is measured; from this, the mass of the positive electrode current-collecting foil sheet measured in advance is subtracted to calculate the mass of the positive electrode active material layer; and based on the resulting mass and the thickness of the positive electrode active material layer of the punched piece, the desired density is calculated.

The positive electrode plate can be obtained by, for example, forming the positive electrode active material layer on the positive electrode current-collecting foil sheet. For example, a positive electrode composite material slurry including the present positive electrode active material is applied to the positive electrode current-collecting foil sheet, and dried to form a coating layer, and the resulting coating layer is compressed to form a positive electrode active material layer, and thus the positive electrode plate is obtained. The positive electrode composite material slurry can include a binder, a conductive aid, and a solvent such as N-methyl-2-pyrrolidone (NMP), in addition to the present positive electrode active material.

### (Non-Aqueous Electrolyte Secondary Battery)

A non-aqueous electrolyte secondary battery according to the present embodiment (hereinafter also called “the present battery”) has the above-described positive electrode plate. In the present battery, because it includes the present positive electrode active material, gas production at the time of storage can be reduced and degradation of capacity retention at the time of repeated use under high-temperature conditions can be reduced.

The present battery can comprise an electrode assembly that includes the positive electrode plate, as well as a non-aqueous electrolyte solution, and it may comprise a battery case for accommodating the electrode assembly and the non-aqueous electrolyte solution. The battery case may include an exterior package having an opening, and a sealing plate for sealing the opening. Each of the exterior package and the sealing plate is preferably made of metal, and can be formed by using aluminum, aluminum alloy, iron, iron alloy, or the like. Between the electrode assembly and the exterior package, a resin sheet may be provided as an electrode holder. Alternatively, the battery case may be made of a laminated film. The laminated film has a multilayer structure formed of a metal layer and a resin layer stacked on top of one another, for example. The edges of the laminated film can be fused together to form a pouch-shaped battery case.

The electrode assembly may include a negative electrode plate and a separator, in addition to the above-described positive electrode plate. In the electrode assembly, the positive electrode active material layer of the positive electrode plate faces a negative electrode active material layer of the negative electrode plate, with the separator interposed therebetween. The electrode assembly may be a stack-type one that is formed by stacking the positive electrode plate, the negative electrode plate, and the separator, or may be a wound-type one that is formed by stacking the positive electrode plate, the negative electrode plate, and the separator and winding the resulting long stack. After the long stack is wound, the wound-type electrode assembly may be pressed into a flat shape.

The negative electrode plate usually has a negative electrode current-collecting foil sheet and a negative electrode active material layer. The negative electrode plate can have the negative electrode active material layer on one side or both sides of the negative electrode current-collecting foil sheet. The negative electrode current-collecting foil sheet is a metal foil sheet that is formed by using a copper material such as copper and copper alloy, for example. The negative electrode active material layer includes a negative electrode active material, and it may further include one or more types selected from the group consisting of a conductive aid, a thickener, and a binder.

Examples of the negative electrode active material include carbon-based active material particles, metal-based active material particles, and the like. Examples of the carbon-based active material particles include particles of one or more types of carbon materials selected from the group consisting of graphite such as natural graphite and artificial graphite, hard carbon, soft carbon, and amorphous-coated graphite. Examples of the metal-based active material particles include particles of a metallic element such as an elemental metal or a metal oxide including an element selected from the group consisting of silicon (Si), tin (Sn), antimony (Sb), bismuth (Bi), titanium (Ti), and germanium (Ge). Examples of the metal-based active material particles include particles of one or more types selected from the group consisting of Si, SiOx (x=0.5 to 1.5), a Si—C composite (hereinafter also called “a SiC composite”), and Sn.

Examples of the binder include cellulose-based resins such as carboxymethylcellulose (CMC), methylcellulose (MC), and hydroxypropylcellulose; polyacrylic acid; styrene-butadiene rubber; and the like. The binder can include one, two, or more types among these. Carboxymethylcellulose (CMC) can also be used as a thickener. Examples of the conductive aid include those mentioned above, and the conductive aid can include one, two, or more types of the above-mentioned conductive aids.

The negative electrode plate can be obtained by, for example, forming the negative electrode active material layer on the negative electrode current-collecting foil sheet. For example, a negative electrode composite material slurry including the negative electrode active material is applied to the negative electrode current-collecting foil sheet, and dried and compressed to form a negative electrode active material layer, and thereby the negative electrode plate is obtained. The negative electrode composite material slurry can include a conductive aid, a binder, and a solvent such as water, in addition to the negative electrode active material.

The separator has a base material, and it may have a functional layer on at least one side of the base material. The base material can be a porous sheet such as a film or a nonwoven fabric, which is made of a resin such as polyolefin (such as polyethylene and polypropylene), polyester, cellulose, polyamide, and/or the like. The base material may have a monolayer structure, or may have a multilayer structure. Examples of the functional layer include an adhesive layer and a heat-resistant layer, and the functional layer can be either one of them, or both. The adhesive layer can be formed with an adhesive agent, for example. The heat-resistant layer can include a filler and a binder, for example.

The non-aqueous electrolyte solution is preferably obtained by adding an electrolyte to a non-aqueous solvent such as an organic solvent. Examples of the electrolyte include LiPF₆, LiBF₄, LiClO₄, LiFSO₃, LiBOB (lithium bis(oxalato) borate), and the like. The non-aqueous electrolyte solution may include one, two, or more electrolytes among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents among these. The non-aqueous electrolyte solution may further include an additive such as vinylene carbonate (VC), vinylethylene carbonate (VEC), and fluoroethylene carbonate.

### EXAMPLES

In the following, the present disclosure will be described in further detail by way of Examples and Comparative Examples.

### Examples 1 to 2, Comparative Examples 1 to 4

### (Preparation of Positive Electrode Plate)

As a first active material, first particles that were a lithium-(transition metal) composite oxide including Ni, Co, and Mn in a molar ratio of Ni:Co:Mn=60:20:20 were prepared. The first particles are at least one of single particles and secondary particles each consisting of 2 to 10 primary particles aggregated together. The average particle size value that was obtainable by averaging the particle sizes of the single particles included in the first particles and the primary particles constituting the first secondary particles included in the first particles (the particle size average) was within the range of 2 to 6 μm.

A second active material having the sphere degree specified in Table 1 was prepared. The second active material is second particles having a second covering layer. The second particles are a lithium-(transition metal) composite oxide that includes Ni, Co, and Mn in a molar ratio of Ni:Co:Mn=55:20:25. The second particles are secondary particles each consisting of 50 or more primary particles aggregated together. The second covering layer covers the surface of each second particle, and includes B (boron) at 1000 ppm relative to the mass of the second particle.

A positive electrode active material including the first active material and the second active material in a mass ratio of 1:1, carbon black as a conductive aid, and polyvinylidene difluoride (PVdF) as a binder were mixed in a mass ratio of (positive electrode active material):(conductive aid):binder=97.5:1.5:1.0, followed by further addition of a proper amount of N-methyl-2-pyrrolidone (NMP) to prepare a positive electrode composite material slurry. The resulting positive electrode composite material slurry was applied to an aluminum foil sheet as a positive electrode current-collecting foil sheet, and dried, to form a coating layer. The resulting coating layer was compressed with a roller to a certain thickness, and the resulting positive electrode active material layer was cut into a certain size, and thereto, an aluminum tab was attached, to obtain a positive electrode plate.

The positive electrode plate was punched into certain planar dimensions and the mass was measured, and the thickness of the positive electrode active material layer of the punched piece was measured. From this, the mass of the positive electrode current-collecting foil sheet measured in advance was subtracted, to calculate the mass of the positive electrode active material layer included in the punched piece. Based on the thickness and the mass of the positive electrode active material layer, the density of the positive electrode active material layer was calculated, which was 3.50 g/cm³.

### (Preparation of Negative Electrode Plate)

Graphite as a negative electrode active material, carboxymethylcellulose (CMC) as a thickener, and styrene-butadiene rubber (SBR) as a binder were mixed together in a mass ratio of (negative electrode active material):thickener:binder=98:1:1, and the resultant was dispersed in water to prepare a negative electrode composite material slurry. The resulting negative electrode composite material slurry was applied to a copper foil sheet as a negative electrode current-collecting foil sheet, and dried and compressed with a roller into a certain thickness to form a negative electrode active material layer, followed by cutting the resultant into a certain size and attaching a nickel tab, to obtain a negative electrode plate.

### (Preparation of Test Cell)

The positive electrode plate and the negative electrode plate were stacked together with a polyolefin separator interposed therebetween, and thereby a stack-type electrode assembly was obtained. The resulting electrode assembly was inserted into an exterior package made of an aluminum laminated film, and a non-aqueous electrolyte solution was injected thereinto, followed by sealing the opening of the exterior package, to obtain a test cell. The non-aqueous electrolyte solution was prepared by mixing ethylene carbonate (EC), dimethyl carbonate (DMC), and ethyl methyl carbonate (EMC) in a volume ratio of EC:DMC:EMC=30:30:40 and, in the resulting mixed solvent, dissolving lithium hexafluorophosphate (LiPF₆) as an electrolyte in a concentration of 1.15 mol/L, followed by adding vinylene carbonate (VC) as an additive in 1.0 mass % relative to the total amount of the mixed solvent.

### [Measurement of Sphere Degree of Second Active Material]

With a scanning electron microscope (SEM), an SEM image of particle surfaces of the second active material used in each of the Examples and the Comparative Examples was captured. With imageJ (free software), the area S₂ and the peripheral length L₂ of the projected image of the second active material in the SEM image were measured. The sphere degree of the second active material was calculated as the ratio between the radius of a hypothetical perfect circle having the area S₂ and the radius of a hypothetical perfect circle whose circumference was the same as the peripheral length L₂, by the above-mentioned equation (ii). The calculated sphere degrees of 20 or more second active materials in the SEM image were averaged, and the resultant was regarded as the sphere degree of the second active material. Results are given in Table 1.

### [Measurement of Average Particle Size (D50) of First Active Material and Second Active Material]

With a particle size distribution analyzer (manufactured by Malvern Panalytical, “Mastersizer-3000”), the average particle size (D50) of the first active material and the second active material used in each of the Examples and the Comparative Examples was measured. Results are given in Table 1.

### [Measurement of Average Primary Particle Size of Second Active Material]

With a scanning electron microscope (SEM), an SEM image of particle surfaces of the second active material used in each of the Examples and the Comparative Examples was captured. With image analysis software (manufactured by MOUNTECH, “Mac-View”), 20 or more primary particles were selected in the SEM image of the second active material, and the major-axis diameters (the longest major-axis diameters) of them were determined, followed by obtaining the average value of them, which was regarded as the average primary particle size. Results are given in Table 1.

### [Evaluation of Amount of Gas Produced During Storage]

Under conditions at a temperature of 25° C., the test cell prepared in each of the Examples and the Comparative Examples was subjected to constant-current charging at a current density of 0.2 mA/cm² until 4.25 V was reached, and it was then subjected to constant-voltage charging at a current density of 4.25 V until 0.04 mA/cm² was reached. After 10 minutes of resting, constant-current discharging was performed at a current density of 0.2 mA/cm² until 3.0 V was reached. The amount of gas produced during this time was determined, which was regarded as a pre-storage gas production amount.

Subsequently, under conditions at a temperature of 25° C., the test cell was subjected to constant-current charging at a current density of 0.2 mA/cm² until 4.25 V was reached, and it was then subjected to constant-voltage charging at 4.25 V until a current density of 0.04 mA/cm² was reached. After storage in a thermostatic chamber at 60° C. for 20 days, constant-current discharging was performed at a current density of 0.2 mA/cm² until 3.0 V was reached. The amount of gas produced during this time was determined, which was regarded as a post-storage gas production amount.

The pre-storage gas production amount was subtracted from the post-storage gas production amount to calculate the amount of gas produced during storage (the during-storage gas production amount). The during-storage gas production amount in Example 1 was defined as 100, and the during-storage gas production amount in Example 2 and Comparative Examples 1 to 4 was calculated as a value relative to the during-storage gas production amount in Example 1. Results are given in Table 1.

### [Evaluation of Capacity Retention in Cycle Test]

Under conditions at a temperature of 25° C., and also under conditions at a temperature of 40° C., cycle testing of the test cell prepared in each of the Examples and the Comparative Examples was carried out in the procedure described below. From the capacity retention calculated for the cycle test at 40° C., the capacity retention calculated for the cycle test at 25° C. was subtracted, and thereby the difference in capacity retention [%] was calculated. Results are given in Table 1.

### (Cycle Test)

The test cell was subjected to constant-current charging at a current density of 0.2 mA/cm² until 4.25 V was reached, and it was then subjected to constant-voltage charging at 4.25 V until a current density of 0.04 mA/cm² was reached. After 10 minutes of resting, constant-current discharging was performed at a current density of 0.2 mA/cm² until 3.0 V was reached. Subsequently, the test cell was subjected to constant-current charging at a current density of 0.2 mA/cm² until 4.18 V was reached, and it was then subjected to constant-voltage charging until at a current density of 0.04 mA/cm² was reached. Subsequently, constant-current discharging was performed at a current density of 0.2 mA/cm² until 3.48 V was reached, and the discharged capacity during this time was determined, which was regarded as the discharged capacity at the first cycle. This charge-discharge cycle was defined as one cycle, and 400 cycles were carried out and the discharged capacity at the 400th cycle was determined. By the following equation, capacity retention [%] was calculated.

$$Capacity retention [ \% ] = ( ( Discharged capacity at 400 th cycle ) / ( Discharged capacity at first cycle ) ) \times 100$$

TABLE 1

| | Comp. | Comp. | | | Comp. | Comp. |
|---|---|---|---|---|---|---|
| | Ex. 1 | Ex. 2 | Ex. 1 | Ex. 2 | Ex. 3 | Ex. 4 |
| First active material | | | | | | |
| Average particle size (D50) [μm] | 4.1 | 4.1 | 4.1 | 4.1 | 4.1 | 4.1 |
| Second active material | | | | | | |
| Average particle size (D50) [μm] | 16.4 | 14.3 | 15.8 | 17.4 | 15.7 | 15.7 |
| Average primary particle size [μm] | 1.4 | 1.5 | 1.6 | 1.3 | 1.5 | 1.3 |
| Sphere degree | 0.758 | 0.765 | 0.774 | 0.797 | 0.814 | 0.829 |
| Evaluation | | | | | | |
| During-storage gas production amount | 115 | 115 | 100 | 104 | 92 | 73 |
| Difference in capacity retention [%] | 0.32 | 0.32 | 0.89 | 1.05 | 1.74 | 1.73 |

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode active material comprising:
a first active material having an average particle size (D50) from 2 to 10 μm; and
a second active material having an average particle size (D50) from 12 to 20 μm, wherein
the first active material includes first particles that are a lithium-(transition metal) composite oxide, the first particles are at least one of single particles and secondary particles, the secondary particles each consist of 2 to 10 primary particles aggregated together,
the second active material includes second particles that are a lithium-(transition metal) composite oxide, the second particles are secondary particles each consisting of 50 or more primary particles aggregated together, and
the second active material has a sphere degree from 0.770 to 0.810.

2. The positive electrode active material according to claim 1, wherein both the first particles and the second particles include Ni at 50 mol % or more relative to a total number of moles of metallic element except Li.

3. The positive electrode active material according to claim 1, wherein an average particle size value that is obtainable by averaging particle sizes of the single particles included in the first particles and the primary particles constituting the secondary particles included in the first particles is from 2 to 6 μm.

4. The positive electrode active material according to claim 1, wherein an average primary particle size of the primary particles constituting the secondary particles of the second particles is from 1.2 to 2.0 μm.

5. The positive electrode active material according to claim 1, wherein
the second active material further includes a covering layer that covers at least part of a surface of each second particle, and
the covering layer includes one or more elements selected from the group consisting of B, Al, Co, Mo, W, Ga, In, and Ti.

6. The positive electrode active material according to claim 5, wherein
the covering layer includes B, and
a content of B in the covering layer is from 600 to 1400 ppm relative to a mass of the second particle.

7. A positive electrode plate comprising an active material layer including the positive electrode active material according to claim 1.

8. The positive electrode plate according to claim 7, wherein a density of the active material layer is from 3.0 to 4.0 g/cm³.

9. A non-aqueous electrolyte secondary battery comprising the positive electrode plate according to claim 7.
